(19) United States
(12) Patent Application Publication
(10) Pub. No.: US 2013/0212702 A1
(43) Pub. Date: Aug. 15, 2013

(54) Apparatus and Method for Data Security on Mobile Devices

(71) Applicant: Redporte Inc., (US)

(72) Inventors: Christophe Niglio, San Francisco, CA (US); Karen Flannery, San Francisco, CA (US); Thang Dao, San Jose, CA (US); Kiet Le, Santa Clara, CA (US)

(73) Assignee: REDPORTE INC., San Francisco, CA (US)

(21) Appl. No.: 13/735,998

(22) Filed: Jan. 7, 2013

Related U.S. Application Data
(60) Provisional application No. 61/584,160, filed on Jan. 6, 2012.

(51) Int. Cl. G06F 21/36

(52) U.S. Cl. CPC G06F 21/36
USPC 726/28

(57) ABSTRACT

A mobile device includes a lock screen configured to prevent unauthorized or inadvertent access to the mobile device by limiting access to the mobile device while displaying through the lock screen applications available on the mobile device.

### CROSS-REFERENCE TO RELATED APPLICATION

This application claims priority to U.S. Provisional Patent Application 61/584,160, filed Jan. 6, 2012, entitled “Methods for Data Security on Mobile Devices.”

### FIELD OF THE INVENTION

This invention relates generally to mobile devices, such as Smartphones, Tablets and the like. More particularly, this invention relates to data security on mobile devices.

### BACKGROUND OF THE INVENTION

Mobile devices are becoming pervasive. Due to their small size and large value, they are susceptible to theft. Therefore, it is desirable to develop new security techniques, in particular data security techniques, for mobile devices.

### SUMMARY OF THE INVENTION

A mobile device includes a lock screen configured to prevent unauthorized or inadvertent access to the mobile device by limiting access to the mobile device while displaying through the lock screen applications available on the mobile device.

### BRIEF DESCRIPTION OF THE FIGURES

The invention is more fully appreciated in connection with the following detailed description taken in conjunction with the accompanying drawings, in which:

FIG. 1 illustrates a mobile device configured in accordance with an embodiment of the invention.

FIG. 2 illustrates a graphical user interface utilized in accordance with the prior art.

FIG. 3 illustrates a graphical user interface utilized in accordance with an embodiment of the invention.

Like reference numerals refer to corresponding parts throughout the several views of the drawings.

### DETAILED DESCRIPTION OF THE INVENTION

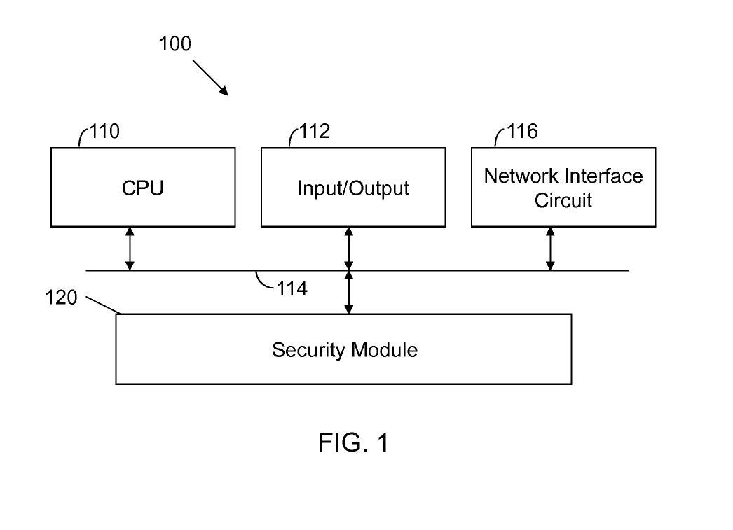

FIG. 1 illustrates a mobile device 100 configured in accordance with an embodiment of the invention. The mobile device 100 includes standard components, such as a central processing unit 110 and input/output devices 112 connected via a bus 114. The input/output devices 112 may include a touch display, keyboard, trackball and the like. A network interface circuit 116 is also connected to the bus 114 to provide connectivity to a network (not shown), which may be any wired or wireless network.

A security module 120 is also connected to the bus 114. The security module may be executable code stored in a memory. Alternately, the security module may be hardwired logic, for example in an integrated circuit or a field programmable logic device. Regardless of the implementation technique, the security module performs one or more of the operations discussed below.

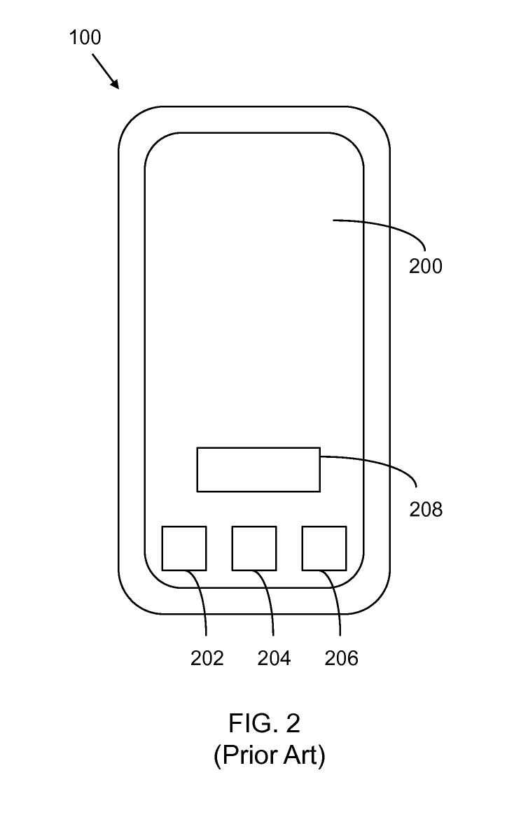

FIG. 2 illustrates mobile device 100. In this view, a display 200 is shown. The display 200 displays various applications 202, 204, 206 and 208 that may be invoked by a user.

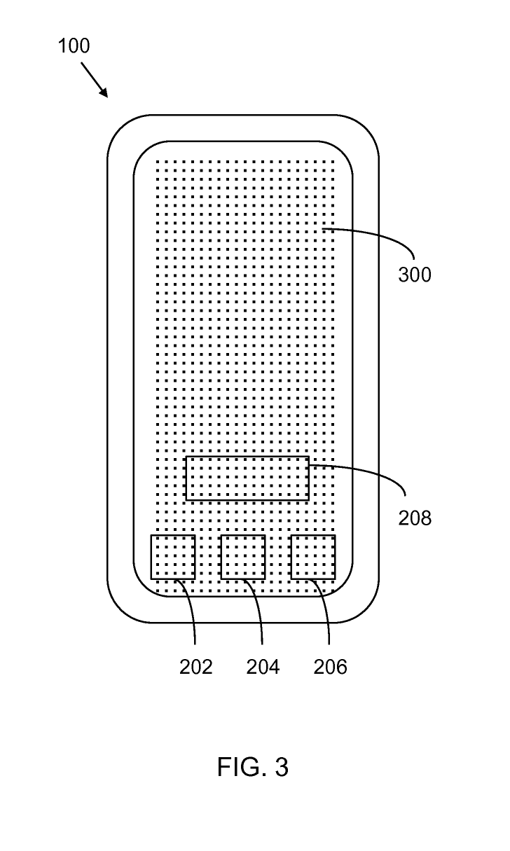

FIG. 3 illustrates the mobile device 100 with a security feature of the invention invoked. In particular, a lock screen 300 is shown. The lock screen 300 is transparent, translucent or filtered such that there is indicia of a locked state. The locked state may be indicated by a lock, by text or simply by some type of altered appearance. The locked state still allows one to view the applications 202, 204, 206 and 208 associated with the device when it is accessible or otherwise unlocked.

### Lockscreen

On a mobile device (or device) equipped with a display, a lock screen (“Lockscreen”) is a display feature that prevents access to applications or additional screens.

### Proximity Lockscreen

The proximity Lockscreen (“Proximity Lockscreen”) is controlled by the proximity of the device to one or multiple items or devices. In other words, the Proximity Lockscreen is selectively invoked based upon proximity between the mobile device and some other device. The proximity may be established with a variety of range sensing mechanisms, such as, without limitation, radio frequency communications links (e.g., Bluetooth, ZigBee, RFID, WiFi, etc), optical communication links, and location information.

Proximity item selection is a technique used to select which devices are to be considered in the operation of the Proximity Lockscreen. The devices considered for the operation of the Proximity Lockscreen are called “Authorized Devices”. A list of items authorized to communicate with the device may be used for this purpose, such list may be referred to as a “Pre-known Device List”.

In cases where the Pre-known Device List is updated independently of the Security System, new devices may be excluded from the Authorized Devices until the user acknowledges the new device(s) are to be used in the operation of the Security System.

### Location Lockscreen

The location Lockscreen (“Location Lockscreen”) is invoked in response to the location of the Device. The location may be established with a variety of techniques, such as GPS, triangulation, cell tower, etc.

Location selection techniques may include:

“Unlock Here” or “Lock Here” buttons that are used to indicate a location used in the operation of the Location Lockscreen;

“Unlock Path” or “Lock Path” buttons may be used to select a series of connected locations forming a path on which the Device may be unlocked or locked, respectively; such path may be derived from common roadways or empirically recorded paths between locations;

“Automated Location Unlock”, a technique which consists of recording frequent locations and duration of device usage at those location and establishing a lock/unlock profile tailored to the user;

A graphical interface showing a map allowing the drawing of zones and paths;

An address input from the user, a menu item in an application that includes locations or addresses, or an import mechanism from a location or address database; a category or another qualifier of the location record may be used to import and select location usage for the Location Lockscreen; and,

A learning interface which may be enabled to records locations.

A qualifier may be used to indicate the range around a selection that is included in the operation of the Location Lockscreen, such as “Precise Location”, “Surrounding Area”, “Region” which definitions may include a room, a building, a block, a neighborhood or a geographical zone of any size. The qualifier may be dependent on the location technique and its precision (GPS versus triangulation for example).

Each selected location may be used to either activate or bypass the Lockscreen.

### Timeout Lockscreen

The timeout Lockscreen (“Timeout Lockscreen”) is a Lockscreen which is controlled by time events, such as the expiration of an unlock timer.

The Timeout Lockscreen may lock or unlock the Device after a time event. The Timeout Lockscreen may be operated in conjunction with other Lockscreen mechanisms, such as the Proximity Lockscreen or the Location Lockscreen.

### Remote Lockscreen

A remote Lockscreen (“Remote Lockscreen”) is a Lockscreen which is controlled by a remote command. A Remote Lockscreen may disable other unlocking mechanisms, such as those of a Proximity Lockscreen or Location Lockscreen.

### Lock Priority

When various events may lock or unlock a plurality of Lockscreens, a priority system is established such that some events may be enabled or disabled for their respective function in a particular state of the Security System. Such mechanism is referred to as “Lock Priority”.

For example, a Remote Lockscreen may disable some of the clearing events of the Proximity or the Location Lockscreen. Similarly, location may be used to force lock (or unlock) the Device. For this behavior, the Location Lockscreen has a higher priority than other events such as Proximity or Timeout. The relative priority of the Location Lockscreen may also depend on the location itself. In some cases, a logical combination of various lock or unlock events may also be used in combination with the Lock Priority system.

In some cases, a logical combination of various lock or unlock events may be used in combination with the lock state of the system. When concurrent lock and unlock events are present, the security compares the lock state with the priority of the event. The lock state carries a priority level that typically matches the event priority that created the state. For example, if the device is unlocked with a given priority, a lock event of lower priority will be recorded but will not change the device lock state; however, a higher priority lock event will result in locking the device. The device state will be locked with the priority of the lock event.

If the device is unlocked and a higher priority unlock event occurs, the device unlocked state will carry the higher priority level until the event is removed.

In a similar manner, the lock state will carry the highest priority of the prior lock events and may be changed to unlock only if a higher priority unlock event occurs. The lock state of the device includes recorded lock events. Upon removal of the latest event affecting the state of the device, the device lock state changes accordingly with the recorded prior valid events and their respective priorities.

The priority settings may be application dependent. They may be set by the user or derived from user device usage. Typically, a direct user authentication is a high priority unlock event. Similarly, a location unlock may carry a higher priority than a proximity lock.

### Bypass and Timeout Reset

A Lockscreen that is disabled for a clearing event, such as an unlock event associated with the Lockscreen or the user input of a secret code is called a bypassed Lockscreen.

A bypassed Lockscreen may be automatically enabled after a time event (Timeout). Also, when an unlock event occurs, normal operation of the Lockscreen may resume.

### Transparent, Translucent or Filtered Lockscreen

A Transparent, Translucent or Filtered Lockscreen is a Lockscreen through which underlying items are visible, discernable or modified (respectively). Such screen may be used to freeze the underlying screen or prevent user interaction while still providing a one-way interface with the user. Such screens may be called veil screens (“Veilscreen” or “Veil”). A Veil may be used to disable, select or identify the underlying items.

A Veil may also feature sections with different filters or translucency or opacity levels; such regions may be selected by the user; a special Veil may be used to learn or select those regions.

A particular application of a Veilscreen is to allow display of an underlying screen or items without additional programming or dependency on an application programming interface

The device identifies which program is displayed, for example, by querying the screen stack. The device pushes the lock screen on top of the display that consist of a screen with transparent features.

When the lock screen is composed, elements of the underlying screen may be taken into consideration when the translucency of the lock screen is created.

User interaction to the screen in case of a touch sensitive device are intercepted by the lock screen and ignored, selectively passed through or interpreted and executed by the lock screen.

### Sequence Unlock

A sequence (“Sequence”) is a user input of a series of screen item (pad) selections in a particular secret order and/or frequency. A Sequence may be used in place of a secret code in order to unlock a Lockscreen. In some cases, a Sequence is created in conjunction with a secret code. A Sequence may be implemented with a Veilscreen, thus allowing a view (clear or filtered) of the underlying screen. A pad may consist of a screen item or simply screen locations with no visible feature.

A sequence may also consist of a succession of screen states consisting or mimicking another recognizable process such as a game or another application for example. The purpose may be to (i) entertain or (ii) improve security by making the sequence look like the other process or appear to follow its rules.

### Remote Commands

### Remote Channel

The Device may be controlled using a communication channel (“Remote Channel”) such as SMS, MMS, Email or other link to the Device capable of sending a command or receiving data. The Remote Channel may use a relaying server. Commands may include any of the following: lock, unlock, protect, restore, wipe, alarm, locate, file listing or data retrieval.

### Commands Hash

A set of remote commands are initially created, stored on the Device and sent via the Remote Channel. The initial set of remote commands may also be sent via another available communication channel. Remote commands may include the identification of a Remote Channel in cases when such channel(s) is (are) device specific.

Each command may have a unique random code or command hash (“Command Hash”). Only commands containing or derived from the initial codes are validated by the Device.

The Command Hash mechanism provides security to the command channel as commands can only be created by the device. For additional security, a Command Hash may be optionally “signed” or otherwise modified in order to be valid. Also, the Command Hash mechanism simplifies usage as a user does not have to remember the syntax for a particular command, but simply sends or otherwise invokes a Command Hash. A Command Hash may be associated with an email or a program that may be run by a remote device which may invoke the command.

### Other Remote Commands

Other less secure command mechanisms may be used when adequate for a particular Remote Channel or the security required by the command, such as a user input secret code for example. The secret code may be associated with a specific command either directly or with the use of a predetermined command code.

### Data Protection

Device data is protected by encryption, either through a native database API, Platform file system access or by creating an independent storage of the encrypted data.

The encryption may be triggered locally based on security breach detection (such as SIM card replacement, successive failed bypass or application removal attempts) or remotely by sending a command via a Remote Channel.

Device Data Protection with Remote Key

A key is created on the Device at installation (“Remote Key”). The Remote Key is used once. The Remote Key is sent encrypted via the Remote Channel and may be retrieved in order to recover the data.

Device Data Encryption with New Key

In cases where subsequent data protection is required, a new encryption key may be generated (the “New Key”). Each New Key is used once. The New Key is sent encrypted via the Remote Channel and may be retrieved in order to recover the data.

### Data Retrieval

### Data Listing

A listing of Device Data may be retrieved from the Device: 1) when the Security System is in a particular state (after Data protection has occurred, for example); or 2) when the user sends a retrieval command via the Remote Channel.

The Data Listing may be sent via the Remote Channel or another communication channel to the Device that is capable of sending the Data Listing. Data Listing may include a command code used to retrieve elements of the Device Data. Data Listing may be presented in a list of links representing the Device Data, each link may send a retrieval command when activated.

### Device Data Server

Data may be retrieved from the Device: 1) when the Security System is in a particular state (after Data protection has occurred, for example); or 2) when the user sends a retrieval command via the Remote Channel. The retrieved data may be sent via the Remote Channel or another communication channel to the Device that is capable of sending the Data.

### Encrypted Retrieval

Retrieved data may be protected.

### Clear Retrieval

Clear Data may be retrieved. If Data is protected, it may be cleared prior to retrieval.

### Device Restoration

Device Restoration refers to clearing Device Data that has been protected. This is done by inputting a secret code, a Sequence or sending a remote command.

Protected Data may be imported into a new Device and cleared by way of restoring the new Device.

### Lockscreen Applications

Lockscreen Applications are applications that run on top of or from the lock screen. Lockscreen Applications may consist of any application, but typically Lockscreen Applications are commonly used applications which for the user do not pose a security risk to the Device Data, such as phone, clock, calculator, reminders and games or application with a reduced feature set.

A Lockscreen Application may be an advertisement or announcement application; the advertisement may be selected from the location of the Device and/or its users' profile or preferences.

Lockscreen Applications may leverage exiting technologies such as: widgets, HTML5 or Flash and may be available from the Lockscreen.

The Lockscreen may filter through requests for device resources (software or hardware) such as, without limitation, data, computing or local or remote communications.

The lock screen may provide a mechanism to launch select programs that are allowed to display over the lock screen. The mechanism may consist of a separate application screen or of a widget on the lock screen itself.

When a lock screen program is running, the lock screen identifies from the list of displayed programs which program is allowed to be displayed. A lock screen program may then be allowed to be visible when other running programs may be blocked from view.

A program may be authorized to run as a lock screen application in a variety of ways: the user may specifically create a link to the application on the lock screen (via a widget for example). The lock screen may prompt the user at the installation of the program or when the program is first used. Some program may also be allowed to operate on top of the lock screen by default.

### Lockscreen Application Selection

The Security System may be placed in a Lockscreen Application Selection Mode whereby an application may be identified as a Lockscreen Application by the user selecting or starting up the application. The identified application may be allowed to run while the Platform is locked.

The Lockscreen Application Selection Mode may feature a Veilscreen in order to facilitate the selection. Lockscreen applications may also be automatically selected based on a known application list established by survey or installed base feedback.

Lockscreen applications may also be selected by the user when prompted by the Security System as the user closes or uses an application. Related or sub-programs of Lockscreen Applications may be enabled as Lockscreen Applications themselves.

### Lockscreen Application List

The Lockscreen Applications may be identified in a Lockscreen Applications List created from default or selected applications.

### Lockscreen Application Security Profile

The Security System may provide and maintain a Lockscreen Application Security Profile including feedback regarding known exposure when a particular application is allowed to run as a Lockscreen Application. The Security System may be maintained with online updates of such exposure.

### Lockscreen Application Filtering

The Security System may filter or prevent a screen or a command of an application for a more detailed protection, particularly when such command or screen poses a risk to Device Data security.

### Security Levels

An application may have several security levels, such as Run-When-Locked, Run-When-Unlocked, Run-With-Authentication. Lockscreen applications are examples of the Run-When-Locked level. Applications at this level are accessible even when the device is locked. Such applications may have little access to the device features or user data. Run-When-Unlocked applications are the general category of applications with regular access to device and user data. Run-With-Authentication are applications that require a higher level of security, such as data vaults. An application may be categorized based on the OS permission requested by the application.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A mobile device, comprising:
a lock screen configured to prevent unauthorized or inadvertent access to the mobile device by limiting access to the mobile device while displaying through the lock screen applications available on the mobile device.

2. The mobile device of claim 1 configured to receive mobile device updates while the lock screen is displayed.

3. The mobile device of claim 1 wherein the lock screen has a tint.

4. The mobile device of claim 3 wherein the tint displays information.

5. A mobile device, comprising:
a module to resolve concurrent lock and unlock commands to selectively remove a lock screen configured to prevent unauthorized or inadvertent access to the mobile device.

6. The mobile device of claim 5 wherein the module uses a priority system to resolve the lock and unlock commands.

7. The mobile device of claim 5 wherein the concurrent lock and unlock commands are created by independent mechanisms.

8. The mobile device of claim 6 wherein the priority system is user specified.

9. A mobile device, comprising:
a module to output information to a lock screen previously configured to prevent unauthorized or inadvertent access to the mobile device.

10. The mobile device of claim 9 wherein the module is launched after the lock screen is configured.

11. The mobile device of claim 9 wherein the module is authorized by a user.

12. The mobile device of claim 9 wherein the module is authorized from an online database of permitted programs.

13. The mobile device of claim 9 wherein the module prevents outputting of certain information.
